(19) United States
(12) Patent Application Publication
(10) Pub. No.: US 2012/0124400 A1
(43) Pub. Date: May 17, 2012

(54) METHOD FOR CONTOLLING CONNECTION BETWEEN TERMINALS USING LOW SPEED NETWORK COMMUNICATION AND DEVICE USING THE SAME

(75) Inventor: Seok Jin YOON, Daejeon (KR)

(73) Assignee: Electronics and Telecommunications Research Institute, Daejeon (KR)

(21) Appl. No.: 13/296,697

(22) Filed: Nov. 15, 2011

(30) Foreign Application Priority Data
Nov. 16, 2010 (KR) 10-2010-0113763

(51) Int. Cl. G06F 15/16; G06F 1/26; H04W 52/02

(52) U.S. Cl. 713/310; 709/232

(57) ABSTRACT

Disclosed is a terminal device for controlling connection between terminals by using low speed network communication. The terminal device includes a first transmission/reception unit for making a request for connection information required for high speed data communication with a connection terminal, to which the terminal device desires to connect, and receiving the connection information from the connection terminal, a network controller for determining a high speed network module to be used for high speed data communication with the connection terminal based on the connection information, and a second transmission/reception unit for performing high speed data communication with the connection terminal by using a high speed network module determined by the network controller.

### CROSS-REFERENCE TO RELATED APPLICATIONS

This application is based on and claims priority from Korean Patent Application No. 10-2010-0113763, filed on Nov. 16, 2010, with the Korean Intellectual Property Office, the disclosure of which is incorporated herein in its entirety by reference.

### BACKGROUND OF THE INVENTION

1. Field of the Invention

The present invention relates to a method and an apparatus for controlling connection between terminals by using low speed network communication. More particularly, the present invention relates to a method and an apparatus for setting a connection method between two terminals equipped with wireless communication apparatuses by using low speed network communication, and performing high speed network communication through the set connection method.

2. Description of the Prior Art

As various kinds of wireless communication network methods are developed and commercialized, terminals equipped with various wireless network modules therein have been manufactured. The wireless network modules equipped in the terminals may be classified into two types of modules which support low speed data communication by using low power and high speed data communication by using high power.

Because the low speed communication module using low power has little power consumption, it is possible to continuously keep a power supply of the module turned on at normal times, so that the low speed communication module can be always maintained in an accessible state. However, because the high speed communication module using high power has large power consumption, there is a problem in that when a power supply of the module is always turned on even during a standby state, a battery of the terminal is quickly discharged. Further, since each of the communication modules has a different method for setting a network, there are difficulties in that a user of the terminal should individually set the network according to a situation, which requires a method for integratively controlling and managing the modules.

### SUMMARY OF THE INVENTION

Accordingly, as described above, an object of the present invention is to solve difficulties in that when a high speed network module keeps its power supply turned on for high speed communication at all times, power consumption increases and a user should set a network according to each situation in order to use various communication networks.

In accordance with an aspect of the present invention, there is provided a terminal device for controlling connection between terminals by using low speed network communication, the terminal device including: a first transmission/reception unit including one or more low speed network modules, requesting connection information required for high speed data communication with a connection terminal, to which the terminal device desires to connect, and receiving the connection information from the connection terminal; a network controller for determining a high speed network module to be used for high speed data communication with the connection terminal based on the connection information; and a second transmission/reception unit comprising one or more high speed network modules, and performing high speed data communication with the connection terminal by using a high speed network module determined by the network controller.

Further, the terminal device further includes an application program using high speed data communication, wherein the high speed data communication performed by the application program is controlled by the network controller. Further, the first transmission/reception unit includes at least one low speed network module among a Bluetooth communication module, a ZigBee communication module, a Radio Frequency Identification (RFID) communication module, and InfraRed (IR) communication module. Further, the first transmission/reception unit keeps its power supply turned on at all times.

Further, the connection information includes information of a supportable high speed network module and setup information of the high speed network module. The network controller controls a power supply of the second transmission/reception unit. Further, the second transmission/reception unit is in an “Off” state or in a sleep mode while high speed data communication is not performed. Further, in the second transmission/reception unit, only a power supply of a high speed network module determined by the network controller is in an “On” state.

In accordance with another aspect of the present invention, there is provided a method for controlling connection between a first user terminal and a second user terminal by using low speed network communication, the method including: making a request for connection information required for high speed data communication to the second user terminal by using a low speed network module by the first user terminal; receiving the connection information from the second user terminal by the first user terminal; determining a high speed network module to be used for high speed data communication with the second user terminal based on the connection information by the first user terminal; and performing high speed data communication with the second user terminal by using a determined high speed network module by the first user terminal.

Further, the method further includes the step of applying power to a determined high speed network module and performing a network setup after the step of determining the high speed network module.

Further, when the second user terminal does not include a high speed network module supporting wireless communication, the second user terminal accesses an internet through a wired network and the first user terminal accesses the internet through a high speed network module, so that the first user terminal and the second user terminal are connected to each other.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the conception and structure of a user terminal according to an embodiment of the present invention;

FIG. 2 is a flowchart describing a connection process between two terminals according to an embodiment of the present invention; and

FIG. 3 is a flowchart illustrating a connection control procedure performed in a user terminal according to an embodiment of the present invention.

### DETAILED DESCRIPTION OF THE EXEMPLARY EMBODIMENTS

Hereinafter, an exemplary embodiment of the present invention will be described with reference to the accompanying drawings. A construction of the present invention and operation and effects according to the construction will be understood by the detailed description below.

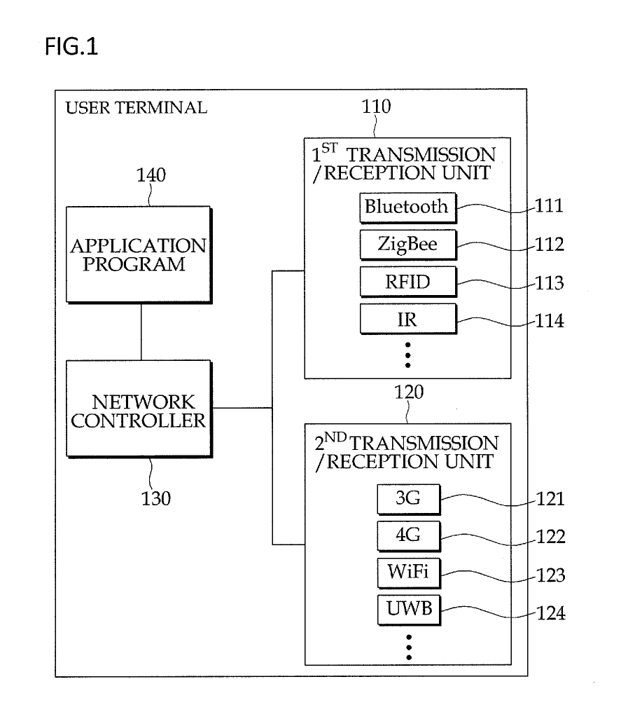

FIG. 1 is a block diagram illustrating the conception and structure of a user terminal according to an embodiment of the present invention. As shown in FIG. 1, the user terminal includes a first transmission/reception unit 110 for low speed network communication, a second transmission/reception unit 120 for high speed network communication, a network controller 130 for selecting and controlling a communication network to be used, and an application program 140 using the network communication.

In the following description, the user terminal refers to various mobile apparatuses, UE (User Equipment), a mobile station, a fixed or mobile subscriber unit, a pager, or any different kind of device capable of operating in a wireless environment, but the user terminal of the present invention is not limited thereto.

Referring to FIG. 1, the user terminal includes a first transmission/reception unit 110 for low speed network communication and a second transmission/reception unit 120 for high speed network communication. Each of the first transmission/reception unit 110 and the second transmission/reception unit 120 may include one or more communication modules and the example is illustrated in FIG. 1.

As shown in FIG. 1, the first transmission/reception unit 110 may include a local area low speed communication module which is a Bluetooth communication module 111, a ZigBee communication module 112, a Radio Frequency Identification (RFID) communication module 113, an InfraRed (IR) communication module 114, etc., but the first transmission/reception unit 110 of the present invention is not limited thereto. Further, for example, the first transmission/reception unit 110 may include only one communication module among the Bluetooth communication module 111 and the ZigBee communication module 112 which are commonly included in other user terminals.

The low speed communication modules 111, 112, 113, and 114 included in the first transmission/reception unit 110 enable the performance of low speed communication in a local area and are operated at low power, so that they consumes little power when they are used. Therefore, although a power supply of the communication modules 111, 112, 113, and 114 included in the first transmission/reception unit 110 is continuously in an “On” state at normal times, the power consumption of the user terminal is not large. Accordingly, the first transmission/reception unit 110 continuously keeps its power supply turned on even during a standby state.

As shown in FIG. 1, the second transmission/reception unit 120 may include a high speed communication module, such as a 3G communication module 121, a 4G communication module 122, a WiFi communication module 123, an Ultra WideBand (UWB) communication module 124, etc., but the second transmission/reception unit 120 of the present invention is not limited thereto. The high speed communication modules 121, 122, 123, and 124 included in the second transmission/reception unit 120 enable the performance of high speed communication of high capacity data and are operated at higher power in comparison with the low speed communication modules 111, 112, 113, and 114, so that they consumes a large quantity of power while they are used. Therefore, when a power supply of the high speed communication modules 121, 122, 123, and 124 included in the second transmission/reception unit 120 is continuously in an “On” state at normal times, the user terminal consumes a greatly large quantity of power. Accordingly, the second transmission/reception unit 120 is controlled to keep its power supply turned off or in a sleep mode consuming minimum power while data communication is not performed. The network controller 130 is connected to the first transmission/reception unit 110 and the second transmission/reception unit 120 and performs functions of selecting a communication module to be used in the first transmission/reception unit 110 and the second transmission/reception unit 120, applying power, and controlling a network such as a network setup, etc.

The application program 140 is connected to the network controller 130 in order to use a wireless communication network and may receive support of optimal wireless communication network access from the network controller 130. The application program 140 can communicate with other terminals by using a communication network set by the network controller 130.

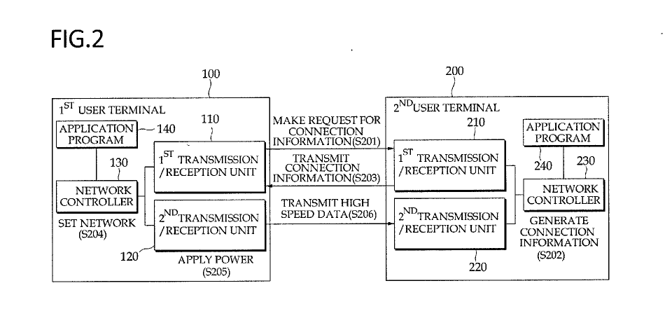

FIG. 2 is a flowchart describing a connection process between two terminals according to an embodiment of the present invention. In FIG. 2, the process of high speed data communication performed by connection between a first user terminal 100 and a second user terminal 200 is illustrated. As shown in FIG. 2, the first user terminal 100 and the second user terminal 200 may have the same elements.

First, when the first user terminal 100 finds the second user terminal 200 to which the first user terminal 100 desires to connect, the first user terminal 100 makes a request for connection information to a first transmission/reception unit 210 of the second user terminal 200 (step S201).

The connection information refers to connection information required for high speed data communication between a user terminal and a connection terminal, to which the user terminal desires to connect. In FIG. 2, the connection information refers to network connection information required for wireless communication between the first user terminal 100 and the second user terminal 200. The connection information includes information required for high speed data communication between the first user terminal 100 and the second user terminal 200. For example, the connection information may include information of a high speed network module, which the second transmission/reception unit 220 of the second user terminal 200 can support, and setup information of the high speed network module. For example, when the high speed network module, which the second transmission/reception unit 220 of the second user terminal 200 can support, is a WiFi communication module, the connection information may include Dynamic Host Configuration Protocol (DHCP)-related information such as an Internet Protocol (IP) address, a basic gateway, a Domain Name Server (DNS) address, etc. and connection code information such as Wired Equivalent Privacy (WEP) code information, etc.

The first user terminal 100 can perform low power communication with the second user terminal 200 through the low speed communication modules 111, 112, 113, and 114 included in the first transmission/reception unit 110. At this time, it is possible to perform the low speed data communication only when the first transmission/reception unit 210 of the second user terminal 200 includes the same communication module as the first transmission/reception unit 110 of the first user terminal 100. For example, when the first transmission/reception unit 110 of the first user terminal 100 includes a ZigBee communication module 112, the first transmission/reception unit 210 of the second user terminal 200 should include the ZigBee communication module 112, so that both user terminals can perform the low speed data communication with low power through the ZigBee network.

The second user terminal 200 receives a request for connection information from the first user terminal 100 and generates the connection information in a network controller 230 in response to the request (step S202). The network controller 230 of the second user terminal 200 is connected to the first transmission/reception unit 210 and the second transmission/reception unit 220 and performs functions of selecting network modules of the first transmission/reception unit 210 and the second transmission/reception unit 220, applying power, setting a network, etc. The network controller 230 can generate information of a high speed network module, which the second transmission/reception unit 220 of the second user terminal 200 can support, and setup information of the high speed network module, as the connection information. The network controller 130 of the first user terminal 100 may perform the same functions as the network controller 230 of the second user terminal 200.

Next, the connection information generated by the network controller 230 of the second user terminal 200 is transmitted to the first transmission/reception unit 110 of the first user terminal 100 through the first transmission/reception unit 210 of the second user terminal 200. The request for the connection information and the response to the request are made through low speed data communication by using the first transmission/reception units 110 and 210 of both user terminals 100 and 200 and such operation is performed with low power. The first transmission/reception units 110 and 210 of both user terminals 100 and 200 continuously keep their power supplies turned on even during a standby state, and the terminal 100 or 200 starts an operation of transmitting and receiving the connection information when the user terminal 100 or 200 finds a terminal to which it desires to connect.

Subsequently, the network controller 130 of the first user terminal 100 sets a network to be used for high speed data communication between the first user terminal 100 and the second user terminal 200 based on the received connection information (step S204). The network controller 130 determines a high speed communication module for high speed data communication between both terminals 100 and 200 based on information of a wireless communication network suitable for data communication of the application program 140 and high speed communication module information included in the second transmission/reception units 120 and 220 of both terminals 100 and 200, applies power to the determined high speed communication module, and performs control operations such as a network setup, etc.

Meanwhile, when the second user terminal 200 cannot use a wireless high speed communication module of the second transmission/reception unit 220 and the second user terminal 200 can perform only low speed communication through the first transmission/reception unit 210, the second user terminal 200 can access an internet through a wired network, e.g. wired Local Area Network (LAN), etc. At this time, the first user terminal 100 can connect to the second user terminal 200 by accessing an internet through a wireless high speed network such as WiFi, 3G/4G, etc. The network controller 130 can determine a network access method in consideration of the existence or absence of the high speed communication module, a current communication channel condition, efficiency for costs, etc.

When the second transmission/reception unit 120 keeps its power supply turned off in a standby section, the second transmission/reception unit 120 applies power to the high speed network module determined by the network controller 130 (step S205). Accordingly, the second transmission/reception unit 120 saves power unnecessarily consumed in sections except for the high speed data communication section and converts an “Off” state of the power supply to an “On” state due to power application of the network controller 130 only in a section where high speed data communication is started.

Further, the second transmission/reception unit 120 may keep its power supply in a sleep mode in a standby section. In the sleep mode, the power supply of the second transmission/reception unit 120 is in an “On” state in the standby section, but other operations such as data transmission/reception, etc. is limited and the power consumption is maintained to a minimum. When the high speed data communication is started, a high speed network module state determined by the network controller 130 is converted to a normal mode from the sleep mode, so that the network module can quickly start the high speed data communication without state conversion of its power supply to the “On” state.

Next, the second transmission/reception unit 120 of the first user terminal 100 performs high speed data communication with the second transmission/reception unit 220 of the second user terminal 200 by using the high speed network module determined by the network controller 130 (step S206). After the high speed data communication is completed, the network controllers 130 and 230 of both terminals 100 and 200 convert the power supply states of the second transmission/reception units 120 and 220 to an “Off” state or a sleep mode.

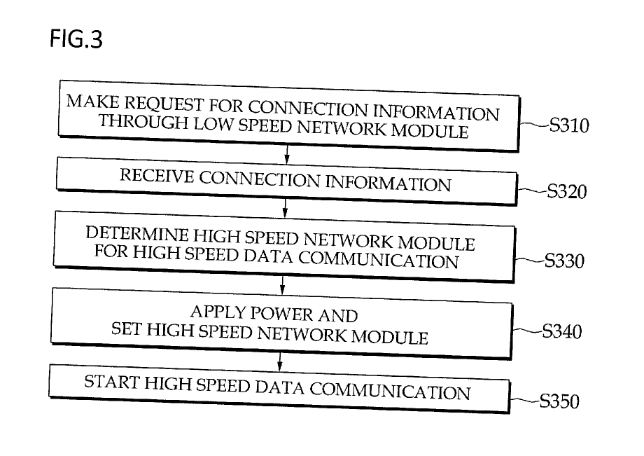

FIG. 3 is a flowchart illustrating a connection control procedure performed in a user terminal for high speed data communication between two terminals according to an embodiment of the present invention. The connection control procedure is largely divided into steps S310 and S320 for a connection setup using a low speed network, steps S330 and S340 for a high speed network setup, and step S350 for high speed data communication.

First, the user terminal makes a request for connection information to another user terminal by using a low speed network module in a standby state (step S310). At this time, the connection information may include information of a high speed network module, which is included in another user terminal and another user terminal can support, and setup information of the high speed network module. Further, in making a request for the connection information, the user terminal may transmit its own connection information, that is, information of a high speed network module, which the user terminal can support, and setup information of the high speed network module. In this case, another user terminal can determine an optimal high speed communication method between both terminals based on the connection information received from the user terminal and its own connection information, and then transmit the optimal method to the user terminal.

Next, the user terminal receives the connection information from another user terminal (step S320). The user terminal and another user terminal perform communication with low power by using a low speed network module.

Next, the user terminal determines a high speed network module to be used for high speed data communication based on the connection information received from another user terminal (step S330). The user terminal can determine a high speed network module capable of supporting the optimal high speed data communication with another user terminal, in consideration of a current network setup condition and a high speed network module, which both the user terminal and another user terminal can support, in order to support the high speed communication to be used in the application program.

When the user terminal determines the high speed network module to be used for the high speed data communication, the user terminal applies power to the determined high speed network module and performs a high speed network setup for the high speed data communication between both terminals (step S340).

Subsequently, the user terminal starts the high speed data communication with another user terminal (step S350). The user terminal can transmit high capacity data to another user terminal and receive the high capacity data from another user terminal through the high speed network module at high speed.

The aforementioned method for controlling connection between both terminals may be realized in the form of, for example, computer software, firmware, or other chips.

According to the present invention, it is possible to set network access through the low speed network device by keeping only a power supply of a low speed network device turned on without continuously keeping a power supply of a high speed network device turned on at normal times. As a result, it is possible to obtain an effect of reducing power consumption of a terminal.

Further, according to the present invention, it is possible to select an optimal high speed network from a plurality of supportable communication networks and transmit high capacity data simply and quickly, by integratively controlling and managing a plurality of wireless communication networks.

Although the present invention has been described in connection with the preferred embodiments, the embodiments of the present invention are only for illustrative purposes and should not be construed as limiting the scope of the present invention. It will be understood by those skilled in the art that various changes and modifications can be made thereto within the technical spirit and scope defined by the appended claims.

What is claimed is:

1. A terminal device for controlling connection between terminals by using low speed network communication, the terminal device comprising:
a first transmission/reception unit comprising one or more low speed network modules, making a request for connection information required for high speed data communication with a connection terminal, to which the terminal device desires to connect, and receiving the connection information from the connection terminal;
a network controller for determining a high speed network module to be used for high speed data communication with the connection terminal based on the connection information; and
a second transmission/reception unit comprising one or more high speed network modules, and performing high speed data communication with the connection terminal by using a high speed network module determined by the network controller.

2. The terminal device as claimed in claim 1, further comprising an application program using high speed data communication, wherein the high speed data communication performed by the application program is controlled by the network controller.

3. The terminal device as claimed in claim 1, wherein the first transmission/reception unit comprises at least one low speed network module among a Bluetooth communication module, a ZigBee communication module, a Radio Frequency Identification (RFID) communication module, and InfraRed (IR) communication module.

4. The terminal device as claimed in claim 1, wherein the first transmission/reception unit keeps its power supply turned on at all times.

5. The terminal device as claimed in claim 1, wherein the connection information comprises information of a supportable high speed network module and setup information of the high speed network module.

6. The terminal device as claimed in claim 1, wherein the network controller controls a power supply of the second transmission/reception unit.

7. The terminal device as claimed in claim 1, wherein the second transmission/reception unit is in an “Off” state or in a sleep mode while high speed data communication is not performed.

8. The terminal device as claimed in claim 1, wherein in the second transmission/reception unit, only a power supply of a high speed network module determined by the network controller is in an “On” state.

9. A method for controlling connection between a first user terminal and a second user terminal by using low speed network communication, the method comprising:
making a request for connection information required for high speed data communication to the second user terminal by using a low speed network module by the first user terminal;
receiving the connection information from the second user terminal by the first user terminal;
determining a high speed network module to be used for high speed data communication with the second user terminal based on the connection information by the first user terminal; and
performing high speed data communication with the second user terminal by using a determined high speed network module by the first user terminal.

10. The method as claimed in claim 9, wherein the low speed network module comprises at least one among Bluetooth communication module, a ZigBee communication module, a RFID communication module, and an IR communication module.

11. The method as claimed in claim 9, wherein the high speed network module comprises at least one among a 3G communication module, a 4G communication module, a WiFi communication module, and an Ultra WideBand (LWB) communication module.

12. The method as claimed in claim 9, wherein the connection information comprises information of a supportable high speed network module and setup information of the high speed network module.

13. The method as claimed in claim 9, wherein when the high speed network module corresponds to a WiFi communication module, the connection information comprises at least one among an IP address, a basic gateway, a DNS address, and WEP code information.

14. The method as claimed in claim 9, wherein the high speed network module is in an “Off” state or in a sleep mode while data communication is not performed.

15. The method as claimed in claim 9, further comprising the step of applying power to a determined high speed network module and performing a network setup after the step of determining the high speed network module.

16. The method as claimed in claim 9, wherein when the second user terminal does not comprise a high speed network module supporting wireless communication, the second user terminal accesses an internet through a wired network and the first user terminal accesses the internet through a high speed network module, so that the first user terminal and the second user terminal are connected to each other.
